(19) United States
(12) Patent Application Publication
(10) Pub. No.: US 2017/0265674 A1
(43) Pub. Date: Sep. 21, 2017

(54) CUP WITH FILTERING SYSTEM

(71) Applicant: Hongjiang Liu, Shenzhen (CN)

(72) Inventor: Hongjiang Liu, Shenzhen (CN)

(21) Appl. No.: 15/224,127

(22) Filed: Jul. 29, 2016

Related U.S. Application Data
(60) Provisional application No. 62/308,894, filed on Mar. 16, 2016.

(51) Int. Cl. A47J 31/00; A47J 31/44; A47J 31/06

(52) U.S. Cl. CPC A47J 31/005; A47J 31/06; A47J 31/4407

(57) ABSTRACT

A cup filtering system may include a main body, an inner bottle and a liquid filtering lid. In one embodiment, the inner bottle is slightly smaller than the main body and can be tightly inserted into a receiving space of the main body, and the lid can be secured on top of the inner bottle. In an exemplary embodiment, the inner bottle has a filtering mechanism at the bottom portion of the inner bottle. A control unit is disposed on top of the inner bottle to control open/close of the filtering mechanism. A lid filter can further filter the liquid filtered by the filtering mechanism of the inner bottle.

### CROSS-REFERENCE TO RELATED APPLICATIONS

This application claims priority under 35 U.S.C. §119 (e) to U.S. Provisional Patent Application Ser. No. 62/308,894, filed on Mar. 16, 2016, the entire contents of which are hereby incorporated by reference.

### FIELD OF THE INVENTION

The present invention relates to a filtering system in a drinking cup, and more particularly to a filtering system including a liquid filtering lid and an inner bottle with a filtering mechanism.

### BACKGROUND OF THE INVENTION

There are many different styles of personal individual consumed water or liquid filter containers available in the market and patented that include plastic and/or metal containers or bottles with various styles of water filters. The personal water or liquid filters either go down inside the water or liquid container or are part of the cap system of the water/liquid filtering container. There is some separate lid or cap water or liquid filters that can be attached, usually screwed on, to various bottles. In most all of these personal water filtering dispensers the water or liquid is drawn out either through a straw type device; sucked out; squeezed out the top center of the container or partially gravity fed out the top center of the personal water or liquid filtering container. However, these liquid filtering containers are not working properly when the user directly put tea leaves or coffee powders in the filter. Therefore, there remains a need for a new and improved drinking cup filtering system to overcome the problems stated above.

### SUMMARY OF THE INVENTION

It is an object of the present invention to provide a cup filtering system with high filtering efficiency even the user directly put the tea leaves or coffee powders directly into the filtering system of the cup.

It is another object of the present invention to provide a cup filtering system that includes a liquid filtering lid and an inner bottle with filtering mechanism to effectively separate the liquid and tea leaves or coffee powders.

In one aspect, a cup filtering system may include a main body, an inner bottle and a lid. In one embodiment, an outer diameter d of the inner bottle is slightly smaller than an inner diameter D of the main body, so the inner bottle can be tightly inserted into a receiving space of the main body.

In an exemplary embodiment, the inner bottle has a filtering mechanism at the bottom portion thereof. The filtering mechanism has a filtering unit that includes a plurality of holes with predetermined size to filter particles. A control unit is disposed on top of the inner bottle to rotatably control the open/close status of the filtering unit.

More specifically, the in one embodiment, the filtering unit may include at least one fan-shaped filtering mesh and a tapered end thereof is fixed a center portion of the filtering mechanism. To change the open/close status of the filtering unit, the filtering mechanism may include a base that is controlled by the control unit to move in a circular manner. The base may include at least one fan- shaped openings and a tapered end thereof is also fixed at the center portion of the filtering mechanism, and the size of the fan-shaped opening is substantially similar to the fan-shaped mesh. So when the fan-shaped opening is rotated to align with the fan-shaped mesh, the liquid can enter the inner bottle from the fan-shaped mesh of the filtering unit through the mesh while the particles can be blocked from entering the inner bottle. On the other hand, the filtering function can be stopped when the fan-shaped opening of the base completely rotates away from the fan-shaped mesh. It is noted that the shape of the mesh and opening can be any shape, not necessarily fan-shaped.

When in use, the coffee powders or tea leaves can be disposed at the bottom of the receiving space of the main body, and the inner bottle can be inserted in the receiving space as well on top of the coffee powders or tea leaves. In the meantime, the filtering mechanism should be open for filtering. The hot water can then be added into the inner bottle to directly contact with the coffee powders or tea leaves and after a predetermined of time, the filtering mechanism should be closed, so the coffee powders or tea leaves can still be left at the bottom of the main body and the coffee or tea can be obtained in the inner bottle.

In another use case, the hot water can be directly added into the receiving space of the main body with the coffee powders or tea leaves. After a predetermined of time, the inner bottle can be inserted into the receiving space with the filtering mechanism open. The coffee or tea can then be squeezed into the inner bottle, and at this time, and the user can close the filtering mechanism to prevent the coffee powders or tea leaves from entering the inner bottle.

In a further embodiment, the lid filter may include a lid body, an inner filtering cup, a side filtering mesh, and a bottom filtering mesh. The side filtering mesh is disposed at an outer surface of the inner filtering cup while the bottom filtering mesh is disposed at the bottom thereof. An inner securing ring is disposed inside the lid body to engage with the inner filtering cup, so the inner filtering cup can be secured inside the lid body. In one embodiment, the bottom filtering mesh can also be disposed on a base. The lid filter is secured on the top portion of the inner bottle when in use, and further includes a liquid outlet, which can be cover by a cover with a sealing unit to prevent the liquid from leaking. It is noted that the inner filtering cup can be taken out from the lid filter and used in a K-Cup machine. It is also noted that even though the inner filtering cup does not initially engage with the inner securing ring, once the inner filtering cup is inserted into the lid body and the lid body starts to screw down on the top portion of the inner bottle, the inner filtering cup can be eventually engaged with the inner securing ring to be securely disposed in the lid body.

### BRIEF DESCRIPTION OF THE DRAWINGS

FIG. 1 illustrates a main body, an inner bottle and the lid of the cup with the filtering system in the present invention.

FIG. 2 illustrates the filtering mechanism for the inner bottle when the filtering valve of the filtering system is open.

FIG. 2a illustrates the filtering mechanism for the inner bottle when the filtering valve of the filtering system is closed.

FIG. 3 shows that the inner bottle is inserted into the main body.

FIG. 3a shows that the inner bottle is fully inserted into the main body.

FIG. 4 illustrates the liquid filtering lid in the present invention.

FIG. 5 illustrates an exploded view of the liquid filtering lid in the present invention.

FIG. 6 is a schematic view of a detachable filtering mechanism.

FIG. 6a is an exploded view of the detachable filtering mechanism in FIG. 6.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

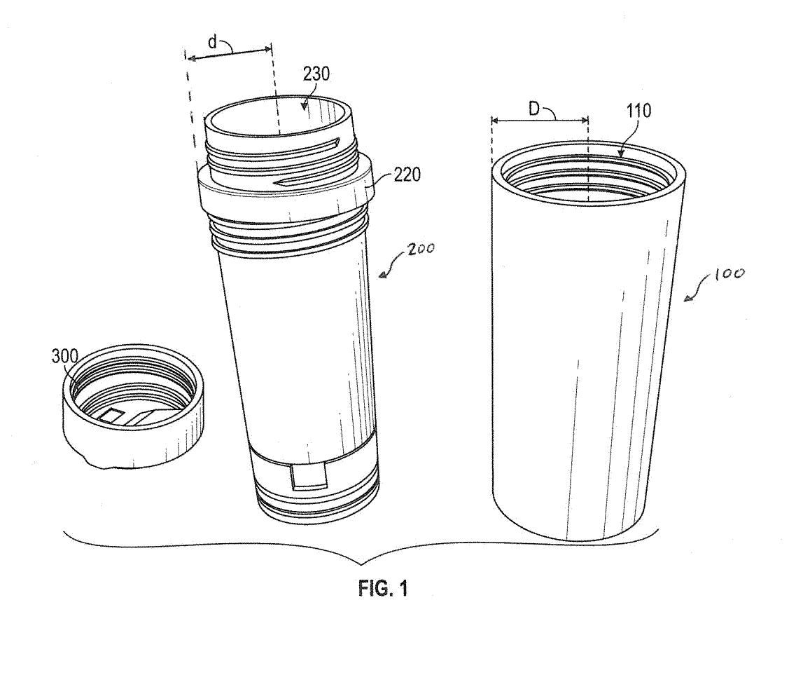

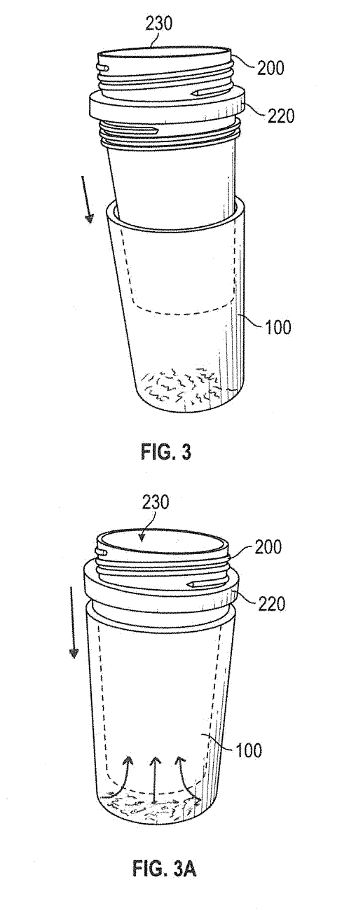

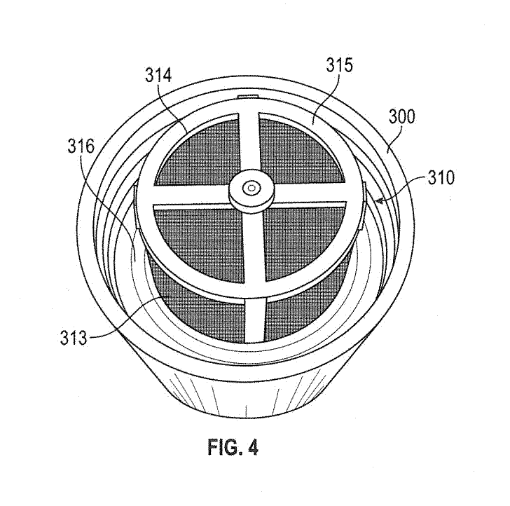

In one aspect, referring to FIG. 1, a cup filtering system may include a main body 100, an inner bottle 200 and a lid 300. In one embodiment, an outer diameter d of the inner bottle 200 is slightly smaller than an inner diameter D of the main body 100, so the inner bottle 200 can be tightly inserted into a receiving space 110 of the main body 100, as shown in FIGS. 3 and 3a.

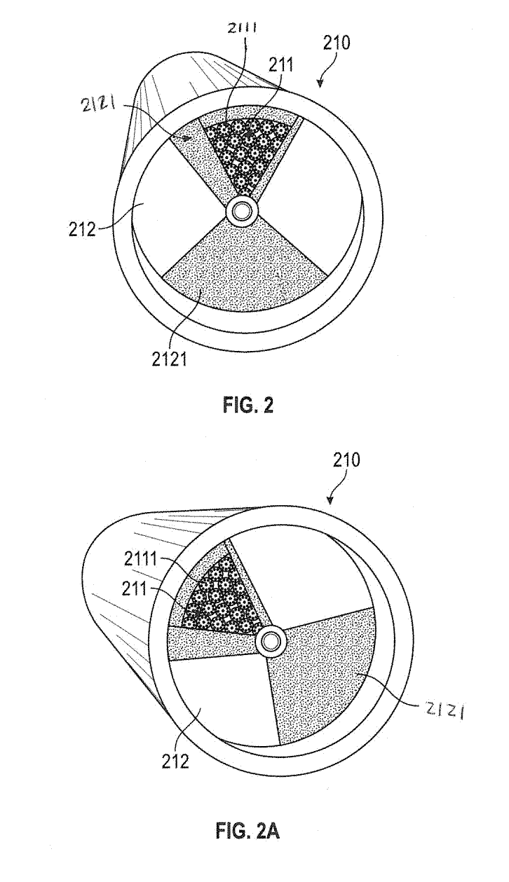

In an exemplary embodiment, as shown in FIGS. 2 and 2a, the inner bottle 200 has a filtering mechanism 210 at the bottom portion thereof. The filtering mechanism 210 has a filtering unit 211 that includes a plurality of holes with predetermined size to filter particles. A control unit 220 is disposed on top of the inner bottle 200 to rotatably control the open/close status of the filtering unit 211.

More specifically, the in one embodiment, the filtering unit 211 may include at least one fan-shaped filtering mesh 2111 and a tapered end thereof is fixed a center portion of the filtering mechanism 210, as shown in FIGS. 2 and 2a. To change the open/close status of the filtering unit 211, the filtering mechanism 210 may include a base 212 that is controlled by the control unit 220 to move in a circular manner. The base 212 may include at least one fan-shaped openings 2121 and a tapered end thereof is also fixed at the center portion of the filtering mechanism 210, and the size of the fan-shaped opening 2121 is substantially similar to the fan-shaped mesh 2111. So when the fan-shaped opening 2121 is rotated to align with the fan-shaped mesh 2111, the liquid can enter the inner bottle 220 from the fan-shaped mesh 2111 of the filtering unit 211 through the mesh while the particles can be blocked from entering the inner bottle 220. On the other hand, the filtering function can be stopped when the fan-shaped opening 2121 of the base 212 completely rotates away from the fan-shaped mesh 2111. It is noted that the shape of the mesh and opening can be any shape, not necessarily fan-shaped. It is also noted that the control unit can be used to control the movement of the filtering unit 211, while the base 212 is fixed.

When in use, the coffee powders or tea leaves can be disposed at the bottom of the receiving space 110 of the main body 100, and the inner bottle 110 can be inserted in the receiving space 110 as well on top of the coffee powders or tea leaves as shown in FIG. 3. In the meantime, the filtering mechanism 210 should be open for filtering. The hot water can then be added into the inner bottle to directly contact with the coffee powders or tea leaves and after a predetermined of time, the filtering mechanism 210 should be closed, so the coffee powders or tea leaves can still be left at the bottom of the main body 100 and the coffee or tea can be obtained in the inner bottle 200.

In another use case, the hot water can be directly added into the receiving space 110 of the main body 100 with the coffee powders or tea leaves. After a predetermined of time, the inner bottle 200 can be inserted into the receiving space 110 with the filtering mechanism 210 open. The coffee or tea can then be squeezed into the inner bottle 210 as shown in FIG. 3A, and at this time, and the user can close the filtering mechanism 210 to prevent the coffee powders or tea leaves from entering the inner bottle 200.

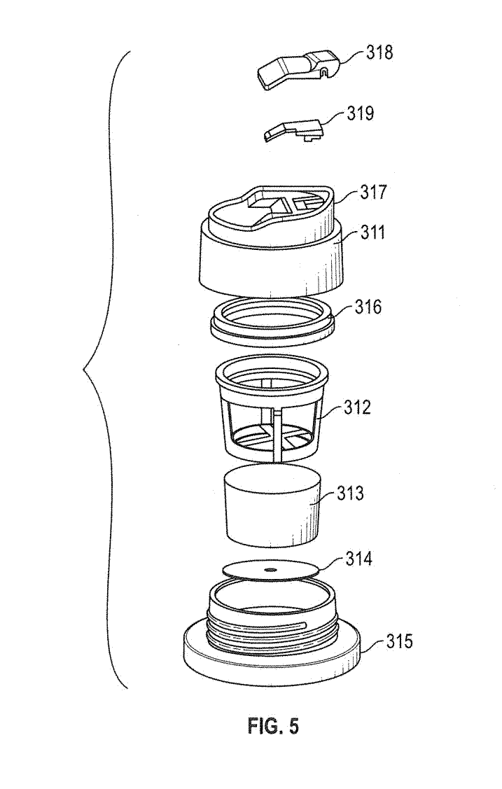

In a further embodiment, as shown in FIGS. 4 and 5, the lid may include a filter 310 including a lid body 311, an inner filtering cup 312, a side filtering mesh 313, and a bottom filtering mesh 314. The side filtering mesh 313 is disposed at an outer surface of the inner filtering cup 312 while the bottom filtering mesh 314 is disposed at the bottom thereof. An inner securing ring 316 is disposed inside the lid body 311 to secure the inner filtering cup 312. In one embodiment, the bottom filtering mesh 314 can also be disposed on a base 315. The lid filter 310 is secured on the top portion of the inner bottle 200 when in use, and further includes a liquid outlet 317, which can be cover by a cover 318 with a sealing unit 319 to prevent the liquid from leaking. It is noted that the inner filtering cup 312 can be taken out from the lid filter 310 and used in a K-Cup machine.

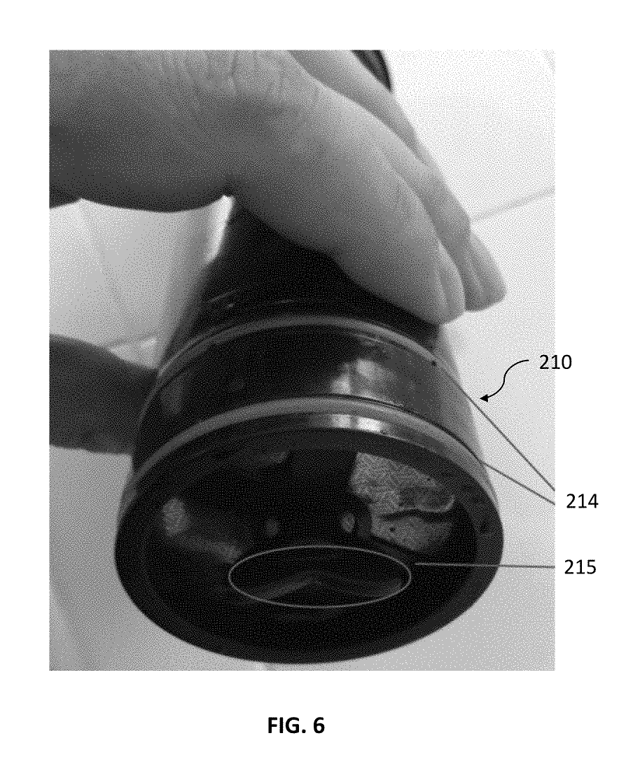

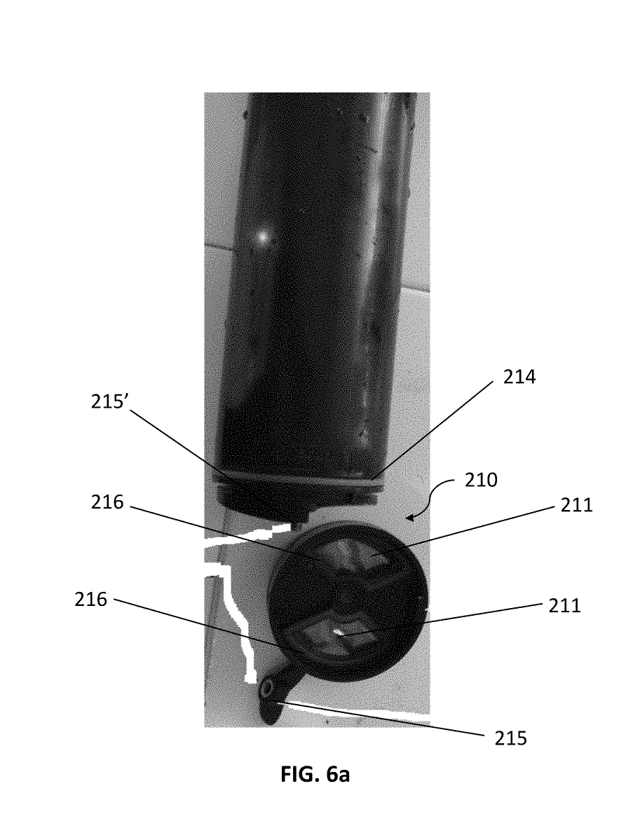

In still a further embodiment, the filtering mechanism 210 can be detached from the main body 100. As shown in FIGS. 6 and 6a, the filtering mechanism 210 can be attached to the main body through a securing unit 215 and a protrusion 215′. More specifically, the securing unit 215 has a screw hole 2151, and the protrusion 215′ is configured to penetrate the filtering mechanism 210 to engage with the screw hole 2151 of the securing unit 215. Once the securing unit 215 is tightened, the filtering mechanism 210 can be attached to the bottom of the main body 100. It is noted that there are one or more sealing gaskets 214 to prevent the liquid from leaking, and the filtering unit 211 is surrounded by an inner gasket 216 to prevent water leaking as well.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A cup filtering system comprising a main body having a receiving space, an inner bottle having a filtering arrangement at a bottom portion thereof, and a liquid filtering lid, wherein the inner bottle is configured to be inserted into the receiving space of the main body, and the filtering arrangement has a filtering unit and a control unit, which is configured to control an open/close status of the filtering unit, and wherein when coffee powders or tea leaves are disposed inside the receiving space with the hot water, the inner bottle with the filtering arrangement open is inserted into the receiving space to squeeze the water into the inner bottle from the filtering arrangement to separate the liquid and the coffee powders or tea leaves.

2. The cup filtering system of claim 1, wherein the filtering unit includes at least one filtering mesh and a tapered end thereof is secured at a center portion of the filtering arrangement.

3. The cup filtering system of claim 2, wherein the filtering arrangement has a base with at least one opening and a tapered end thereof is secured at a center portion of the filtering arrangement.

4. The cup filtering system of claim 3, wherein the base is controlled by the control unit to move in a circular manner in the filtering arrangement, so when the opening of the base is rotated to align with the filtering mesh, the liquid enters the inner bottle from the filtering unit through the filtering mesh while the particles are be blocked from entering the inner bottle.

5. The cup filtering system of claim 1, wherein the lid filter includes a lid body, an inner filtering cup, a side filtering mesh, and a bottom filtering mesh, and the side filtering mesh is disposed at an outer surface of the inner filtering cup while the bottom filtering mesh is disposed at the bottom thereof.

6. The cup filtering system of claim 5, wherein an inner securing ring is disposed inside the lid body to secure the inner filtering cup.
